(19) United States
(12) Patent Application Publication
(10) Pub. No.: US 2004/0072478 A1
(43) Pub. Date: Apr. 15, 2004

(54) Production management device for a manufacturing and/or assembling device

(76) Inventors: Walter Sticht, Attnang-Puchheim (AU); Harald Strauss, Pinsdorf (AU)

Correspondence Address: WILLIAM COLLARD, COLLARD & ROE, P.C., 1077 NORTHERN BOULEVARD, ROSLYN, NY, 11576, US

(21) Appl. No.: 10/451,747

(22) PCT Filed: Dec. 19, 2001
(86) PCT No.: PCT/AT01/00397

(30) Foreign Application Priority Data
Dec. 29, 2000 (AT) A21622000

(51) Int. Cl. H01R 9/22

(52) U.S. Cl. 439/894

(57) ABSTRACT

The invention relates to a plant management system (2) for a production and/or assembly line (1) with several processing and/or assembly devices (13) having a programmable control system (19) and with actuators (17) and detection and/or monitoring means connected thereto, in particular sensors (18), for detecting operating data, and having at least one information output device (27). The control system (19) is connected to a data processing unit (25) and a control and/or optimisation module is provided. The data processing unit (25) or the information output device (27) has a communication module with signal-transmitting means (28) and signal-receiving means (29) for the data transfer with at least one mobile management and operating unit (30).

The invention relates to a plant management system of the type outlined in the generic part of claim 1.

AT 383 691 B filed by the present applicant discloses a device for signalling operating status and error messages for assembly machinery consisting of several inter-connected individual stations and control and monitoring systems co-operating with these individual stations, which are linked to a central control system and a signalling system connected to it. This signalling system has a central signal transmitter and a transportable signal receiver, which is provided with signalling devices. The disadvantage of this arrangement is the large number of signalling devices needed for the complex sequences required for such assembly machines in order to control and monitor their operation, which impairs the mobility of operating personnel and lacks the overall view needed to enable rapid action to maintain fault-free operation of such systems. This results in cost-intensive downtimes and places very high psychological demands on operating personnel, virtually ruling out the possibility of looking after several such systems simultaneously.

Other known signalling systems designed to indicate operating states are used as a means of forwarding measurement values from different measurement points to a central control and monitoring unit, remote from the systems incorporating the measuring points, in which the signals are transmitted by means of stationary runs of connecting cables or wirelessly via radio. Even these systems require a large number of different signalling systems which hinder transparency but also run the risk of potential incorrect operation.

The objective of the invention is to propose a plant management system, which guarantees operating personnel a high degree of mobility and reduces the response time within which steps can be taken to remedy faults, whilst ruling out incorrect operation as far as possible.

This objective is achieved by the invention on the basis of the features set out in the characterising part of claim 1. The surprising advantage of this approach is that signals and data of an extensive production and/assembly system consisting of a several individual stations with a plurality of functional groups converge on a central control unit and are transmitted to a mobile signal receiver in an encoded, clearly distinguishable and detectable format, which may be used to control sequences, quality standards, quantities, etc., from virtually any point and enables a remote diagnosis when faults occur and, in many cases, enables these faults to be rapidly and efficiently remedied, or steps to be taken which require a decision in the form of manual intervention in the programme routine in order to remedy faults, change equipment, select variants, etc.. Another advantage is the fact that the signals and data are transmitted in digital format, thereby avoiding transmission faults which might otherwise occur due to the additional use of check and assignment signals. The management and/or optimisation module optimises the transmission of information so that it is always transmitted in a specific sequence according to stored decision criteria, and these criteria may be based on the resultant cost of delaying dealing with the problem, downtime and lost production costs, a drop in quality standards, for example, which are stored in the form of a priority catalogue. Jobs requiring nothing more than pure maintenance or inspection, on the other hand, are given a lower priority and are repeated at a given time until the problem is no longer pending, as would be the case if an operator had remedied the fault for example, and a corresponding check-back signal has been generated accordingly.

Other embodiments described in claims 2 and 3 are also of advantage because they offer additional optimisation by converting the information into texts which can not be misinterpreted, e.g. taken from a speech module containing pre-set text modules, which effectively avoids incurring costs due to incorrect reactions based on incorrectly interpreted information.

Claims 4 to 7 describe advantageous embodiments, whereby data signals and data can be transmitted unhampered between the signal transmitter and the signal receiver even if they are spatially separated or direct visual contact is inadequate, and individual adjustments can be made to suit whatever circumstances prevail at the site where production and assembly lines are installed and operated.

Also of advantage are the embodiments described in claims 8 and 9 since they enable a plant to be serviced, i.e. cover all monitoring, control and maintenance functions needed to ensure fault-free operation, in extensive production and assembly lines of this type, irrespective of the location from which the mobile management and operating unit is operated. Operating data can also be exchanged between plant designed to run the same type of processes within a production and/or assembly line, enabling the operating routines to be optimised by so-called diagnostic or automatic optimisation processes, the features of which are detected by several plants.

Claims 10 to 14 describe yet other advantageous embodiments, whereby the routing for setting specifications is optimised based on a knowledge of the site at which the specifications are needed and whatever location the mobile management and operating unit happens to be in. These advantages apply in particular to very extensive production and/or assembly lines and several management and operating units communicating with them, enabling another decision criterion to be set by the member of staff handling operation, etc., on the basis of different qualification codes.

Claim 15 describes another advantageous embodiment which enables fault-free parallel operation, in which case several production and/or assembly lines can be operated simultaneously by one mobile management and operating unit.

Another advantageous embodiment is described in claim 16, whereby plant at different installation sites can also be operated from a management and operating unit within an overall complex of a production site.

Also of advantage are the embodiments defined in claims 17 and 18, as a result of which all jobs to be set up can be retrieved from a pre-defined catalogue of specifications from which the job description, requirements, etc. are initiated. The steps to be taken may be presented in the form of a brief message detailing the job requirements as a whole or in steps.

An embodiment described in claim 19 is of advantage because it secures full mobility in the operation of plants of this type.

Another advantageous embodiment is defined in claim 20, which affords full mobility and also enables settings to be entered without requiring direct manual operation, whilst also permitting verbal communication, in which words, letters and alpha-numeric combinations can be transmitted as signals from the signal receiver and issued to the signal transmitter in verbal format.

Another embodiment is possible as specified in claim 21, whereby additional information for the operating personnel can be transmitted.

Claim 22 defines another advantageous embodiment enabling information to be imparted directly without screens, etc..

By virtue of an advantageous embodiment defined in claim 23, the management and operating system is supplied with additional background information, e.g. for entertaining and relaxing operating personnel, in particular music transmissions, and the information output can also be selected from different options, thereby catering for the individual wishes of an operator of these types of plants.

Another possible embodiment is defined in claim 24, which also enables larger pieces of equipment to be rendered mobile.

In accordance with one advantageous embodiment described in claim 25, the management and operating system can be operated independently of a fixed network.

Claim 26 describes another embodiment, which indicates to the operating personnel where information for particular measures is to be found and enables these to set without incurring a time delay.

As a result of the advantageous embodiment described in claim 27, the information transmitted from a signal transmitter is unambiguously assigned, thereby constituting a blocking system so that signals for any measures to be taken can be transmitted to the relevant plant without being mixed up.

As a result of the embodiment described in claim 28, an exact log is produced so that any faults which occur can be tracked and statistically evaluated.

Finally, an embodiment defined in claim 29 has advantages since it provides an effective means of preventing unauthorised or inadvertent intervention in the control system.

The invention further relates to a method of operating a plant management system of the type outlined in the generic part of claim 30.

The objective of the method is to minimise the response time involved in rectifying faults or applying decisive routine changes.

This objective is achieved by the characterising features defined in claim 30. The surprising advantage obtained as a result is that the plant management system proposed by the invention can be operated on a mobile basis and with unambiguous assignment of operating and management functions for a production and/or assembly line, enabling an operator to receive signals from several plants without any time delay and perform operating and management functions.

A method sequence such as that proposed in claim 31 is also of advantage because it enables measures to be set up in a specific sequence on the basis of different predefined optimisation criteria to be transmitted in sequence. This enables plants of this type to be operated on the basis of cost-related factors and quality-related factors. These criteria are predefined so that the optimisation process can be operated automatically.

In one advantageous approach defined in claim 32, the exact measures which have been set can be subsequently checked and any variances from the norm can be incorporated in an automatic learning programme to fine tune the management system.

The method defined in claim 33 achieves a particularly high degree of efficiency using several management and operating units, since routing is optimised in order to achieve shorter access times and servicing times.

Finally, the features described in claim 34 offer advantages because in addition to information about the measures to be set up, additional information about how these measures should be applied is also available to the operating personnel, thereby ensuring fault-free implementation ruling out misinterpretation.

To provide a clearer understanding, the invention will be described in more detail below with reference to the embodiments illustrated in the appended drawings.

Of these:

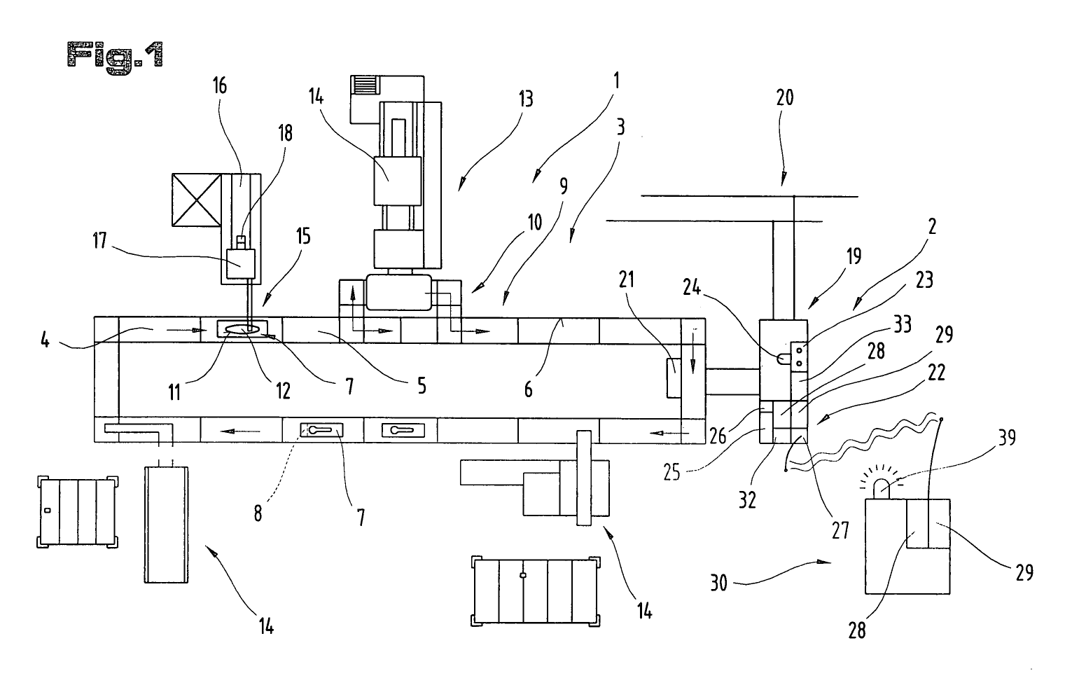

FIG. 1 shows a production and/or assembly line with a plant management system proposed by the invention;

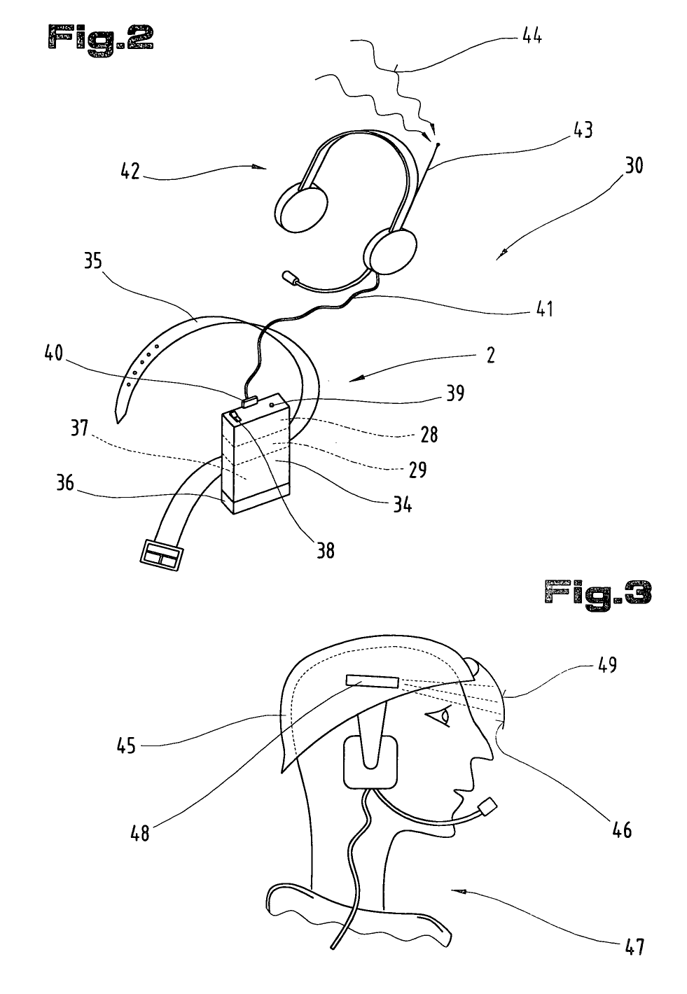

FIG. 2 shows a control and operation system of the plant management system proposed by the invention;

FIG. 3 shows another embodiment of the management and operating system of the plant management system proposed by the invention;

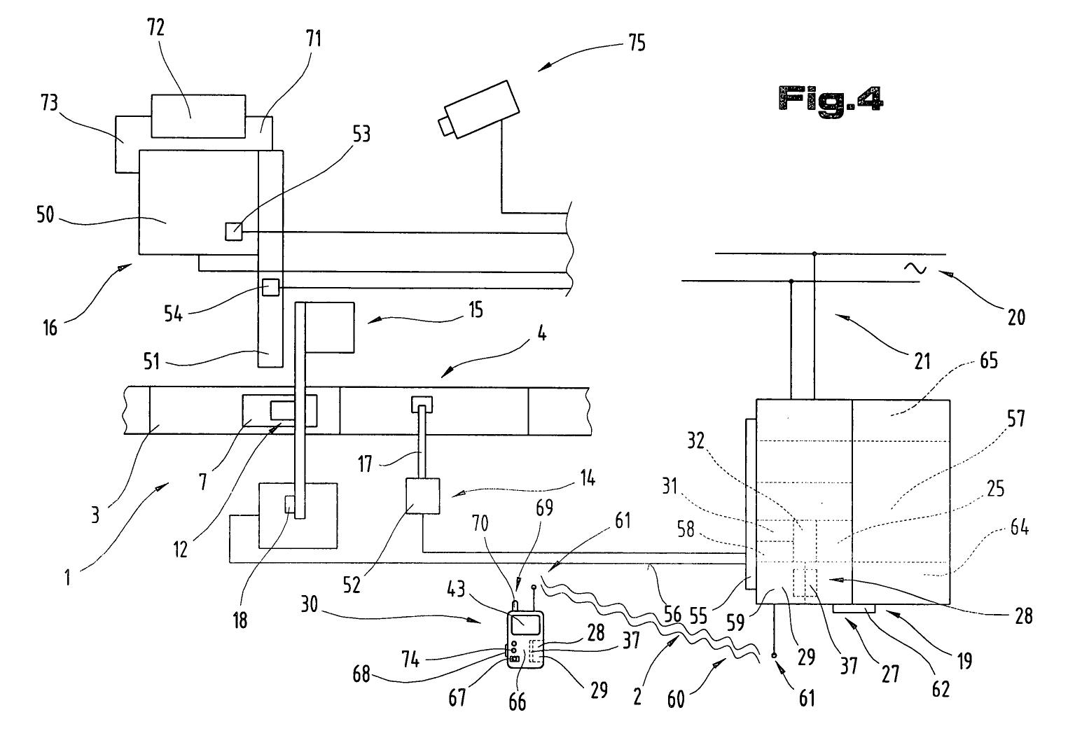

FIG. 4 depicts another embodiment of the plant management system proposed by the invention with a part-section of a production and/or assembly line.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 illustrates a production and/assembly line 1 with a plant management system 2 proposed by the invention. It comprises a conveyor system 3, which, in the example illustrated, is rectangular in shape and is made up of a number of consecutive individual stations 4, e.g. linear stations and node stations. The conveyor system 3 is provided with height guide tracks 5 and lateral guide tracks 6. In these, workpiece holders 7 are guided along the conveyor system 3, for example automatically, i.e. fitted with a separate drive 8. As illustrated, the conveyor system 3 has so-called main conveyor runs 9 and subsidiary conveyor runs 10, enabling very flexible sequencing and offering a variety of possible combinations for the production and/or assembly steps which can be performed. The workpiece holders 7 have seatings 11 for workpieces 12 which have to be finished or are needed in assembly processes.

Processing and/or assembly units 13 are disposed alongside the conveyor system 3, e.g. production machines 14 for boring, milling, soldering, etc. or handling equipment 15 for inserting, joining, etc., each being assigned a number of delivery systems 16 for the workpieces 12.

Each of these processing and/or assembly units 13 has a series of actuators 17, e.g. valves, drives, cylinders, etc., and is fitted with a plurality of sensors 18, e.g. proximity sensors, pressure sensors, temperature sensors, speed sensors, etc., by means of which the operating states are detected and operating data determined and then transmitted across lines or wirelessly to a control system 19 which controls, monitors and automatically regulates the sequences of the production and/or assembly line 1. The entire production and/or assembly line 1 is also supplied with the power it needs from an external power source 20, e.g. a mains network, via this control system 19.

Many production and/or assembly lines 1 of this type also have supply systems 21, e.g. compressors, lines, etc., for a pressurising medium, in particular compressed.

The control system 19 is equipped with processors which fix the control logic for controlling, regulating and monitoring sequences, preferably a user-programmable controller (“FPS”) of the type known from the prior art, and also forms a control point 22, provided with switch and control devices 23, displays 24, etc.. The control system 19 also has a data processing unit 25 with the requisite interfaces 26 for data input and data output.

In the plant management system 2 proposed by the invention, the control system 19 has an information output device 27 with signal-transmission means 28 and signal-receiving means 29. The information output device 27 communicates, preferably wirelessly, with a management and operating unit 30 which is not dependent on a fixed location and is therefore mobile and permits a continuous transfer of data. The management and operating unit 30 is likewise equipped with signal-transmission means 28 and signal-receiving means 29.

The data processing unit 25 also has a plant operation and/or maintenance file memory module 31 in which verbal messages in the form of texts, text modules and letters are stored. It is connected to a speech module 32 and preferably also has an information system 33, e.g. a radio, which may or may not incorporate a tape and/or CD drive with the requisite evaluation and transmission electronics, by means of which additional information, music, etc., can be transmitted to the operator. As soon as a message or signal relating to operation of the plant is received, any music transmission which might be playing, for example, is interrupted and switched to the background.

FIGS. 2 and 3 illustrated one possible embodiment of the management and operating unit 30 of the plant management system 2. In the embodiment illustrated as an example here, it consists of an appropriate housing 34, which may be accompanied by a belt 35, for example, so as to be portable 35. In the housing 34 is a power source, such as a battery for example, to enable operation, and for the electronic circuit for the signal-transmission means 28 and signal-reception means 29 and for a coding and/or decoding means 37. Other features of the management and operating unit 30 might include, for example, an on-off switch 38 and a display unit 39 for indicating operating status, charge status display, etc.. The management and operating unit 30 is connected via an interface 40 and lines 41 to an audio and image reproduction unit 42, which has a receiving antenna 43 to enable wireless reception of transmitted signals—indicated by arrows 44.

As may also be seen from FIG. 3, another option is to fit a protective helmet 45 with a display screen—display 46—for example, in order to display signals and messages to an operator 47 as well as relaying acoustic information. A display 46, e.g. a so-called liquid crystal display, requires very little power to operate and is commonly used in portable computers or similar display systems known from the prior art, and enables text, symbols and images to be reproduced in excellent output quality.

Instead of a liquid crystal display, another option is to provide a visual output of information by means of a output optical system 48, which outputs the image data on a transparent screen 49 within the range of vision of the operator 47, provided with a coating to reproduce images.

FIG. 4 illustrates how another embodiment of the plant management system 2 proposed by the invention operates, for example for operating an area of a production and/or assembly line 1.

In the operating area illustrated, a workpiece 12 fed from a parts bin 10 by a delivery system 16 and separating device 51 is placed by the handling device 15 in displaceable workpiece holders 7 on the conveyor system 3. Once the workpiece 12 has been placed in the workpiece holder 7, the workpiece holder 7 moves onwards to a downstream individual station 4, at which a production machine 14, e.g. a soldering device 52 is disposed for applying a solder spot to the workpiece 12. The sequence is operated on the basis of the programme instructions from the control system 19, by means of which the requisite actuators 17 are actuated. In order to monitor the sequence, a level sensor 53, for example, is disposed in the parts bin 50 in this operating area, which monitors the situation to ensure that sufficient workpieces 12 are available. A detection system 54 is disposed in the region of the separating device 51, e.g. an optical detection unit 54, which monitors to ensure that the delivered workpiece 12 is in the correct position and optionally controls the quality. Other sensors 18 monitor the readiness of a parts reserve storage, operation of the handling device 15 and the soldering device 52, for example. The sensors 18, the level sensor 53 and the detection system 54 are connected to an input interface 55 of the control system 19 via lines 56, from which the relevant signals are forwarded to a user-programmable controller 57 and acknowledged, preferably as check-back signals, in order to trigger output signals based on the pre-set programme for process sequences at the actuators 17.

In this preferred embodiment, the control system 19 incorporates the data processing unit 25 with the plant operation and/or maintenance file memory module 31, a control and/or optimisation module 58, the speech module 32 and a communication module 59 co-operating with the information output device 27. The control system 19 of the plant operation and control system 2 communicates wirelessly with the management and operating unit 30 via a data transfer module 60. The communication module 61 and the management and operating unit 30 have appropriate transmitter and receiver units 61 for wirelessly transmitting data, signals or information, e.g. for short waves, magnetic fields, optical signals, etc..

Alternatively however, the data transfer module 60 may be designed to operate via a modem 62, in which case it will be connected via the latter to a telecommunication system, such as the WWW, for example, so that the management and operating unit 30 can be operated regardless of where the production and/or assembly line 1 is located. However, the link to the telecommunication system via the modem 62 may also be operated via a line connection between the data transfer module 60 and the modem 62, or alternatively wirelessly.

The control system 19 also has a position locating system 64, e.g. a satellite navigation system 65, by means of which the respective location of the mobile management and operating unit 30 is continuously determined relative to the production and/or assembly line 1 and the individual stations 4, e.g. on the basis of co-ordinates, and the relevant data stored in the management and optimisation module 58.

In the embodiment illustrated as an example here, the control and operation unit 30 is a portable handheld device 66, which may also fulfil a telephone function, and additionally has a display 43 for presenting data, signals and information output in the form of symbols, digits or texts. The management and operating unit 30 is also equipped with a microphone 67 and optionally an interface 68 for connecting a headset, PC, etc..

The primary objective of using the plant management system 2 is to be in a position to initiate steps before faults occur, in order to prevent plant down times. For example, if the level sensor 53 of the parts bin 50 transmits a signal indicating that workpieces 12 in the parts bin 50 have reached a minimum level, the signal arriving at the controller 57 will generate a corresponding text file, e.g. “Parts bin almost empty ”, from the plant operation and maintenance memory module 31 by accessing the speech module 32, which is then transmitted via the communication module 59 and data transfer module 60 to the management and operating unit 30 and appears on the display 43, for example as a text file, or is output as an acoustic message. A signalling unit 69, e.g. a display lamp 70, may simultaneously alert the operator to the fact that there is a message, by flashing. The presence of a message may also be indicated by causing housing parts to vibrate, etc..

The message may also contain a clear identification of the parts bin 50 in question, as well as additional information. e.g. to the effect “Reserve store available” relating to a parts reserve store 72 coupled with the parts bin 50, the status of which is monitored by a sensor 73 and the contents of which can be transferred to the parts bin 50 via an emptying device 71.

On the basis of this information, the operator can initiate steps from the management and operating unit 30 to counteract disruption due to the absence of workpieces 12. In the plant management system 2 proposed by the invention , a predefined text set up before-hand to remedy the problem may also be presented on the display 43 as confirmation, e.g. “Activate parts reserve store ” via an acknowledgement button 74, whereupon the corresponding control signal will be forwarded via the signal-transmission means 28 to the signal-reception means 29 of the message output device 27 and the controller 57, and the corresponding programme step retrieved in order to empty the contents of the parts reserve store 72 into the parts bin 50.

In the embodiment proposed by the invention which incorporates the speech module 32, input may also be via the microphone 67 of the management and operating unit 30 in the form of a numerical code, alphabetic code or as verbal text.

The sequence described above may naturally be applied to any other disruptions or measures designed to manage production and/or assembly lines 1 of this type without interruption and this specific situation has been described merely a an example.

A whole range of faults that would halt the production and/or assembly line 1 can therefore be prevented, thereby significantly increasing the availability of a production and/or assembly line 1 of this type. Furthermore, the unambiguous format of the messages issued for managing operation also prevents incorrect steps from being taken and ensures that the right measures can be initiated immediately in the event of a problem.

The wireless transmission of the messages between the control system 19 and the management and operating unit 30 is preferably effected on the basis of electromagnetic waves in the frequency ranges available for public use. The acoustic signals are preferably transmitted wirelessly via frequency-modulated as well as amplitude-modulated electromagnetic waves. Control signals and/or operating data are preferably transmitted via the respective function by means of clearly allocated electromagnetic waves at a specific frequency. Likewise, it would also be conceivable for this transmission to be operated on the basis of optical signals, e.g. in the infrared range. This being the case, a specific frequency of the optical waves would have to be unambiguously assigned to the respective function and/or the relevant operating data. However, an optical transmission of this data would only be meaningful in situations where the control system 19 and the management and operating unit 30 could be guaranteed to remain within the required visual range and a video system 75 provided for optical monitoring purposes.

The transmission power would have to be configured so that the signals and/or operating data could be transmitted across at least an active range covering several rooms or a building complex, for example.

In order to be able to operate several production and/or assembly lines 1 in parallel with the plant monitoring and management system 2, it is necessary to be able to select so-called channels from several frequency ranges in order to transmit or receive the signals but this is very easy to set up.

The speech module 32 is preferably provided by means of a PC or another computer unit with an appropriate speech-recognition and/or speech-conversion software. Using a preferably adaptive speech-recognition and/or speech-conversion software, the speech module 32 generates an electronic text file from the acoustic signals, which may optionally be further processed and can be output using standard output devices, such as a printer for example. The text file may be generated from the received acoustic signals simultaneously, depending on the computing capacity of the PC, or the speech signal to be converted may be temporarily stored on a storage medium and converted as soon as sufficient computing capacity is free or on the basis of a set of a priority rankings.

It would also be possible to operate several production and/or assembly lines 1 with the plant management system 2 if channel frequencies can be set which are clearly distinguishable or different from one another. By selecting the appropriate channel from the mobile management and operating unit 30, an operator will then be able to select the respective destination point, in other words a specific production and/or assembly line 1, from a number of such lines being monitored. This enables the destination point to be selected on the basis of location, issue or urgency or on any other basis. By using the position locating system 64, e.g. the satellite navigation system 65, optimum use can be made of several management and operating units 30 to cover a very extensive production and assembly line 1, for example.

It is also of particular advantage if the management and operating unit 30 can be activated on the basis of acoustic or speech control. This will enable unrestricted hands-free operation, in which case unmistakable verbal concepts such as “Stop”, “Go”, for example, or coded concepts, such as alpha-numeric combinations, etc., for example, can be set for the relevant functions.

Naturally, video systems 75 offer another monitoring option, enabling individual operating areas to be monitored and image data to be transmitted to the management and operating unit 30. This data might relate directly to operating states or might alternatively be operating data, which can be output in visual format in order to provide the operator with the necessary criteria for taking decisions.

The control and/or optimisation module 58 may have use of a diagnostic system or alternatively may be of a self-learning type, in order to run a desired/actual comparison based on specific operating states and a stored desired state, and automatically specify measures to optimise the plant, the set measures being stored in a specifications register once the desired state has been established.

For the sake of good order, finally, it should be pointed out that in order to provide a clearer understanding of the structure of the plant management system 2 proposed by the invention, it and its individual parts are illustrated to a certain extent out of scale and/or on an enlarged scale or on a reduced scale.

The independent solutions proposed by the invention and the underlying technical objectives may be taken from the description.

Above all, the individual embodiments of the subject matter illustrated in FIGS. 1; 2, 3; 4 may be construed as independent solutions proposed by the invention in their own right. The associated objectives and solutions proposed by the invention may be found in the detailed descriptions of these drawings.

### List of Reference Numbers

| | |
|---|---|
| 1 | Production and/or assembly line |
| 2 | Plant management system |
| 3 | Conveyor system |
| 4 | Individual station |
| 5 | Height guide track |
| 6 | Lateral guide track |
| 7 | Workpiece holder |
| 8 | Drive |
| 9 | Main conveyor |
| 10 | Subsidiary conveyor |
| 11 | Seating |
| 12 | Workpiece |
| 13 | Processing and/or assembly unit |
| 14 | Production machine |
| 15 | Handling device |
| 16 | Delivery system |
| 17 | Actuator |
| 18 | Sensor |
| 19 | Control system |
| 20 | Power source |
| 21 | Supply system |
| 22 | Control point |
| 23 | Switch and control devices |
| 24 | Display element |
| 25 | Data processing unit |
| 26 | Interface |
| 27 | Information output device |
| 28 | Signal-transmission means |
| 29 | Signal-reception means |
| 30 | Management and operating unit |
| 31 | Plant operation and/or maintenance |
| | file memory module |
| 32 | Speech module |
| 33 | Information system |
| 34 | Housing |
| 35 | Belt |
| 36 | Power source |
| 37 | Coding and/or decoding means |
| 38 | On-off switch |
| 39 | Display unit |
| 40 | Interface |
| 41 | Line |
| 42 | Sound and image reproduction system |
| 43 | Receiving antenna |
| 44 | Arrow |
| 45 | Protective helmet |
| 46 | Display |
| 47 | Operator |
| 48 | Output optical system |
| 49 | Screen |
| 50 | Parts bin |
| 51 | Separating device |
| 52 | Soldering device |
| 53 | Level sensor |
| 54 | Detection system |
| 55 | Input interface |
| 56 | Line |
| 57 | Controller (FPS) |
| 58 | Control and/or optimisation module |
| 59 | Communication module |
| 60 | Data transfer module |
| 61 | Transmitter and receiver unit |
| 62 | Modem |
| 63 | — |
| 64 | Position-locating system |
| 65 | Satellite-navigation system |
| 66 | Handheld device |
| 67 | Microphones |
| 68 | Interface |
| 69 | Signalling system |
| 70 | Display lamp |
| 71 | Emptying device |
| 72 | Parts reserve store |
| 73 | Sensor |
| 74 | Acknowledgement button |
| 75 | Video system |

1. Plant management system for a production and/or assembly line with several processing and/or assembly stations having a programmable controller with actuators and detection and/or monitoring means connected to the latter, in particular sensors for detecting operating data, and having at least one information output device, characterised in that the control system (19) is connected to a data processing unit (25), and a control and/or optimisation module (58) is provided, and the data processing unit (25) or the information output device (27) has a communication module (59) with signal-transmission means (28) and signal-reception means (29) for the data transfer with at least one mobile management and operating unit (30).

2. Plant management system as claimed in claim 1, characterised in that a speech module (32) with coding and/or decoding means (37) is provided in the information output device (27) or the communication module (59).

3. Plant management system as claimed in claim 1 or 2, characterised in that a speech module (32) with coding and/or decoding means (37) is provided in the management and operating unit (30) or the communication module (59).

4. Plant management system as claimed in one or more of the preceding claims, characterised in that a data transfer module is provided (60), e.g. for wireless data transmission between the data processing unit (25) or the communication module (59) or the control and/or optimisation module (58) and the management and operating unit (30).

5. Plant management system as claimed in one or more of the preceding claims, characterised in that the data transfer module (60) is designed to transmit or receive electromagnetic waves, in particular frequency-modulated electromagnetic waves.

6. Plant management system as claimed in one or more of the preceding claims, characterised in that the data transfer module (60) is provided in the form of short wave transmitter and receiver units (61).

7. Plant management system as claimed in one or more of the preceding claims, characterised in that the data transfer module (60) is provided in the form of infrared transmitter and receiver units (61).

8. Plant management system as claimed in one or more of the preceding claims, characterised in that the data transfer module (60) is wired to a modem (62) for a telecommunication system, e.g. WWW.

9. Plant management system as claimed in one or more of the preceding claims, characterised in that the data transfer module (60) communicates wirelessly with the modem (62).

10. Plant management system as claimed in one or more of the preceding claims, characterised in that a preferably wireless position locating system (64) is provided between the data processing unit (25) or the management and optimisation module (58) and the management and operating unit (30).

11. Plant management system as claimed in one or more of the preceding claims, characterised in that the position locating system (64) is preferably provided in the form of a satellite navigation system (65).

12. Plant management system as claimed in one or more of the preceding claims, characterised in that the position locating system (64) is provided in the form of shortwave transmitter and receiver units (61).

13. Plant management system as claimed in one or more of the preceding claims, characterised in that the position locating system (64) is provided in the form of transmitter and receiver units (61) for optical signals, in particular in the infrared range.

14. Plant management system as claimed in one or more of the preceding claims, characterised in that the information output device (27) and the management and operating unit (30) have ultrasonic transmitter and ultrasonic receiver means for transmitting signals and/or data.

15. Plant management system as claimed in one or more of the preceding claims, characterised in that the signals and/or data are transmitted between the information output device (27) and the management and operating unit (30) on several frequency ranges or channels.

16. Plant management system as claimed in one or more of the preceding claims, characterised in that the transmission power of the information output device (27) and/or the management and operating unit (30) for wirelessly transmitting signals and/or data is rated to cover a transmission range which optionally encompasses a building complex.

17. Plant management system as claimed in one or more of the preceding claims, characterised in that a plant operating and/or maintenance file memory module (31) is connected to or incorporated in the data processing unit (25) or the control and/or optimisation module (58).

18. Plant management system as claimed in one or more of the preceding claims, characterised in that a plant operating and maintenance file memory module (31) is provided in the management and operating unit (30).

19. Plant management system as claimed in one or more of the preceding claims, characterised in that the management and operating unit (30) is of a portable design and is equipped with sound and/or image reproduction systems (42).

20. Plant management system as claimed in one or more of the preceding claims, characterised in that the management and operating unit (30) is provided in a protective helmet (45) equipped with loudspeaker, microphone and preferably display (46).

21. Plant management system as claimed in one or more of the preceding claims, characterised in that the sound and/or reproduction system (42) has an output optical system (48) for relaying information, in particular symbols or presentations, images, etc., on a screen (49).

22. Plant management system as claimed in one or more of the preceding claims, characterised in that the information is transmitted to the retina of an operator (47) via the output optical system (48).

23. Plant management system as claimed in one or more of the preceding claims, characterised in that the information output device (27) or the communication module (59) co-operates with an information system (33) e.g. radio, tape and/or CD drive.

24. Plant management system as claimed in one or more of the preceding claims, characterised in that the management and operating unit (30) is of a portable design, in particular self-propelled.

25. Plant management system as claimed in one or more of the preceding claims, characterised in that the management and operating unit (30) is supplied by an internal power source (36).

26. Plant management system as claimed in one or more of the preceding claims, characterised in that acoustic and/or optical display units (39), e.g. a display lamp (70), are provided on the management and operating unit (30).

27. Plant management system as claimed in one or more of the preceding claims, characterised in that an identification signal is transmitted by the management and operating unit (30).

28. Plant management system as claimed in one or more of the preceding claims, characterised in that a real-time protocol module is provided in the data processing unit (25) and/or the control system (19).

29. Plant management system as claimed in one or more of the preceding claims, characterised in that the signal and/or data transmission between the information output device (27) and the management and operating unit (30) is encrypted.

30. Method for a plant management system for managing operation and monitoring operating states of at least one production and/or assembly line with several networked individual stations for processing and/or assembling workpieces, which are connected to at least one centralised or decentralised control system and to means connected to the latter for detecting operating states and operating data, as well as to at least one information output device and a management and operating unit, characterised in that the programme sequence based on programme steps is stored in the control system or a data processing unit or a programmable controller and control signals are fed to actuators of the plant in the sequence of the steps or parallel with one another, and the actuators perform sequences, and the sensors monitoring the sequences and other operating data, e.g. relating to the readiness of operating equipment, workpieces, etc., send check-back signals to the control system, and a constant desired-actual analysis is run in a desired-actual comparator and, if an actual value deviates from a desired value, a signal is forwarded to the information output device to report a fault, and a message is generated from texts, text modules, letters, stored in a speech module and assigned to the signal and this message is transmitted via a signal transmitting means of a communication module of the information output device, preferably wirelessly, to a signal-receiving means of the management and operating unit, which is mobile in particular, and is output in the form of an acoustic and/or visual message on a display or a loudspeaker.

31. Method as claimed in claim 30, characterised in that data, signals and information are transmitted to an optimisation test procedure in a management and optimisation module, in which the signals and/or information are ranked on the basis of stored optimisation and/or priority specifications and transmitted in the set sequence from the communication module to the management and operating unit.

32. Method as claimed in claim 30 or 31, characterised in that the data, signals and/or information are available at the management and operating unit until appropriate measures are taken and a confirmation signal is sent from the management and operating unit to the control system, after which a plausibility test is run and, in the event of a positive conclusion, the measures are logged as having been completed.

33. Method as claimed in one or more of claims 30 to 32, characterised in that the respective location of the management and operating unit is monitored and detected by the control system by means of a position locating system and location co-ordinates are stored in the control and/or optimisation module.

34. Method as claimed in one or more of claims 30 to 33, characterised in that specification data in acoustic and/or image format from a maintenance file memory module is assigned to the data, signals and/or information and transmitted to and displayed on the management and operating unit via the output device or the communication module.
